(19) United States
(12) Patent Application Publication
(10) Pub. No.: US 2007/0288521 A1
(43) Pub. Date: Dec. 13, 2007

(54) Multi-mode transfer communication system and method therefor

(75) Inventors: Tien-ming Hsu, Taipei City (TW); Jia-lin Shen, Lujhou City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Delta Electronics, Inc., Taoyuan Hsien (TW)

(21) Appl. No.: 11/796,106

(22) Filed: Apr. 26, 2007

(30) Foreign Application Priority Data
May 19, 2006 (TW) 095117985

(51) Int. Cl. G06F 17/30

(52) U.S. Cl. 707/104.1

(57) ABSTRACT

A multi-mode transfer communication system and a method therefor are provided. The method is used for performing a multi-mode transfer communication and includes steps of providing a medium device having a contact list with a plurality of contact subjects, detecting a connecting request from a user to provide the connection between the medium device and the user, delivering the contact list to the user for selecting therefrom a specific contact subject, detecting a connection status of the specific contact subject for the user to decide to communicate with the specific contact subject or not, and transferring the specific contact subject to communicate with the user.

### FIELD OF THE INVENTION

The present invention is related to a multi-mode transfer communication system and a method therefor, and more particularly to a multi-mode transfer communication system and a method therefor applied in a linked network by using various I/O interfaces to perform a multi-mode transfer communication.

### BACKGROUND OF THE INVENTION

In a conventional automatic telephone switchboard system, a calling subscriber could make a call to the switchboard system and dial an extension number, and then the call would be transferred to the extension phone for a called subscriber via the conventional automatic telephone system. With the development for the switchboard system, a voice automatic telephone switchboard system has been generated. In the voice automatic telephone switchboard system, the calling subscriber can sound the name or the extension number for the called subscriber in the call. After performing the speech recognition with the call by the voice automatic telephone switchboard system, the call could be transferred to the extension phone of the called subscriber.

However, the mentioned automatic telephone switchboard system merely provides the voice to interact with the calling subscriber and the calling subscriber merely uses the voice or keystroke, i.e. sending a DTMF sound, to inform the switchboard system. The mentioned interaction mode does not provide enough information to both of the switchboard system and the calling subscriber. For example, it is thus difficult to provide the list for all extension numbers by the switchboard system or to inform about whether the called subscriber could answer the call at leisure.

Take an example. A calling subscriber makes a call to the conventional automatic telephone switchboard system of A Company to look for Mr. Shen in the RD department, but the calling subscriber knows neither his extension number nor his full name. Under such a condition, it is not helpful for the conventional automatic telephone switchboard system to look for Mr. Shen, and the calling subscriber must request an assistance for the manual telephone.

Take a further example. A calling subscriber makes a call to the conventional automatic telephone switchboard system of B Company to find an engineer in the RD department in order to ask about some techniques, but the calling subscriber does not know which engineer is in his leisure. Thus, the calling subscriber only takes a chance to randomly select an extension number for calling certain engineer. If the selected engineer is not in his place at that time, the calling subscriber must dial another extension number to try whether another engineer could answer the call.

Therefore, the purpose of the present invention is to develop a multi-mode transfer communication system and a method therefor to deal with the above situations encountered in the prior art.

### SUMMARY OF THE INVENTION

It is therefore a first aspect of the present invention to provide a multi-mode transfer communication system and a method therefor applied in the existing link network to obtain information, such as the corresponding contact list and the connection status of contact subjects, and decide whether to transfer or inform a specific contact subject.

It is therefore a second aspect of the present invention to provide a multi-mode transfer communication system and a method therefor system or to inform about whether the called subscriber could answer the call at leisure.

According to a third aspect of the present invention, a method for performing a multi-mode transfer communication is provided. The method includes steps of (a) providing a medium device having a contact list with a plurality of contact subjects, (b) detecting a connecting request from a user to provide the connection between the medium device and the user, (c) delivering the contact list to the user for selecting therefrom a specific contact subject, (d) detecting a connection status of the specific contact subject for the user to decide to communicate with the specific contact subject or not, and (e) transferring the specific contact subject to communicate with the user.

Preferably, the method further includes steps of (f) generating a communication failure signal if a communication between the specific contact subject and the user fails, and (g) sending a call to inform the specific contact subject when the connect status of the specific contact subject is available.

Preferably, the step (f) further includes a step of deciding whether the specific contact subject communicate with the user in response to the call.

Preferably, the medium device, the user and the specific contact subject include a first connection account, a second connection account and a third connection account, respectively.

Preferably, the user is connected to the medium device and the specific contact subject via the respective connection accounts.

Preferably, the contact list has a group list with a plurality of groups, and each group includes corresponding contact subject.

Preferably, the step (c) further includes a step of delivering the group list to the user for selecting one of the groups to show corresponding contact subjects thereof.

Preferably, the steps (c) and (e) are preformed by one selected from a group consisting a voice input, an image input, a text input and a click.

Preferably, the connection status includes the status options including Online, Away, Do Not Disturb and Offline.

According to a fourth aspect of the present invention, a multi-mode transfer communication system is provided. The system includes a detection module detecting whether a connecting request from a user exists, a database including a contact list with a plurality of contact subject, a control module retrieving the contact list from the database according to the connecting request, a communication module delivering the contact list to the user for selecting a specific contact subject of the contact subjects and delivering a connection status of the specific contact subject, thereby determining whether the user communicates with the specific contact subject in response to the connection status.

Preferably, the system further includes a transfer module transferring the specific contact subject to communicate with the user.

Preferably, the detection module generates a communication failure signal to the control module while the specific contact subject fails to communicate with the user.

Preferably, the control module sends a call to inform the specific contact subject according to the communication failure signal via the communication module when the connect status of the specific contact subject is available.

Preferably, the specific contact subject decides to communicate with the user in accordance with the call.

Preferably, the control module communicates with the user according to the decision of the specific contact subject via the transfer module.

Preferably, the detection module, the database, the communication module and the transfer module are all connected to the control module.

Preferably, the contact list is a hierarchical list having a group list with a plurality of groups, and each group includes corresponding contact subjects.

Preferably, the contact list is a hierarchical list having a group list with a plurality of groups, and each group includes corresponding contact subjects.

Preferably, the communication module delivers the group list to the user for selecting one of the groups and show the corresponding contact subject thereof via the control module.

Preferably, the detection module detects respective connection statuses of the contact subject.

According to a fifth aspect of the present invention, a method for multi-mode transfer communication is provided. The method includes steps of (a) sending a connecting request by a user to connect with a medium device, wherein the medium device includes a hierarchical list having a group list with a plurality of groups, (b) receiving the group list, wherein each group includes corresponding contact subject, (c) selecting one of the groups from the group list to show the specific contact subjects corresponding to the selected group, (d) selecting a specific contact subject from the contact subjects to show a connection status of the specific one, and (e) determining whether to communicate with the specific contact subject via a transfer.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a flow chart showing a multi-mode transfer communication system and a method therefor according to a preferred embodiment of the present invention;

FIG. 2 is a flow chart showing the possible processes for delivering the contact list in the flow chart of FIG. 1;

FIG. 3 is a schematic views showing the framework for the multi-mode transfer communication system according to the preferred embodiment of the present invention; and

FIG. 4 is a schematic diagram showing an applied environment according to the system of FIG. 3.

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purposes of illustration and description only; it is not intended to be exhaustive or to be limited to the precise form disclosed.

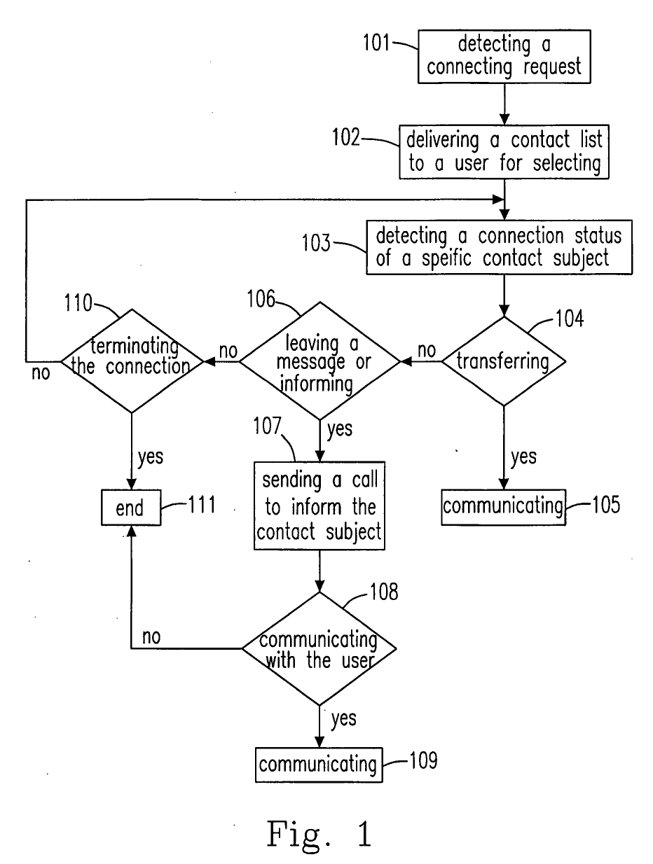

Please refer to FIG. 1, which is a flow chart showing a multi-mode transfer communication system and a method therefor according to a preferred embodiment of the present invention.

Firstly, the present invention provides a medium device to detect whether a connecting request from a user is exist, and provides a connection between the medium device and the user (step 101), in which the medium device having a contact list with a plurality of contact subjects. Further, the medium device would delivery the contact list to the user for selecting therefrom a specific contact subject (step 102). The specific contact subject could be identified to determine, and then a connection status for the specific contact subject is detected to inform the user (step 103). Thus, the user can decide to communicate with the specific contact subject or not in accordance to the connection status (step 104). If the decision for the step 104 is positive, the specific contact subject is transferred to communicate with the user (step 105).

In step 104, if a communication between the user and the specific contact subject fails, such as the connection status for the specific contact subject cannot be communicated with the user or the user abandons to communicate with the specific contact subject, the present invention can inform whether the user wants to leave a message or inform the user of this communication (step 106). If the user decides to inform the specific contact subject, the present invention would send a call to inform the specific contact subject (step 107). Then, the specific contact subject can decide to communicate with the user or not in response to the call (step 108). The user can communicate with the user (step 109) or end the connection (step 111).

Moreover, if the decision for the step 106 is negative, the present invention can inform the user of whether the user wants to terminate the connection (step 110). If the decision for the step 110 is positive, the connection would be ended (step 111). Otherwise, the user can return to the step 102 to re-select another contact subject from the contact list and re-proceed the mentioned steps.

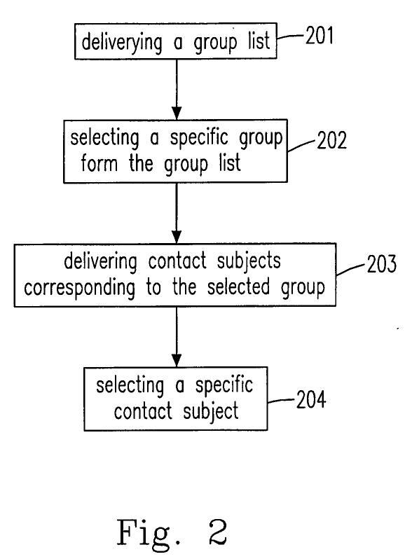

Furthermore, the detailed contents of the contact list and the possible processes for delivering the contact list are shown in FIG. 2. The contact list would be a hierarchical list and includes a group list with a plurality of groups, and each group includes corresponding contact subjects. Thus, the group list would be delivered (step 201) to the user for selecting a specific group from the group list (step 202), and corresponding contact subjects of the specific group is delivered to the user (step 203). Then, the user can select a specific contact subject from the corresponding contact subjects (step 204).

Take an example. A company includes ten departments and each department includes different staffs, respectively. Accordingly, the group list of the contact list for A company includes 10 group and each group includes corresponding contact subjects for the staffs. Accordingly, the group list for showing the respective names of the ten departments would be delivered to the user, and the user can select a specific department, such as the communication department. Further, the contact subjects for the staffs corresponding to the selected department would be delivered to the user. Thus, based on the contact subjects, the user can select a specific contact subject to communicate with a specific staff.

Besides, the contact list for the present invention can include no group list and merely include a plurality of contact subject. Thus, another possible process for delivering the contact list could include steps 203 and 204 without steps 201 and 202.

Further, the medium device, the user and the specific contact subject include a first connection account, a second connection account and a third connection account, respectively. Thus, the user is connected to the medium device and the specific contact subject via the respective connection accounts. The connection status includes the status options including Online, Away, Do Not Disturb and Offline. Accordingly, while the connection status for the specific contact subject is Offline, the user cannot communicate with the specific contact subject. The step for selecting by the user disclosed in the respective steps 102, 104, 106 and 110 in FIG. 1 and the respective steps 202 and 204 in FIG. 2 could be preformed by one selected from a group consisting a voice input, an image input, a text input and a click. Therefore, the present invention includes the ability for speech and image identification and word and signal processing, and provides corresponding information by different input modes, such as voice, image and message, to the user.

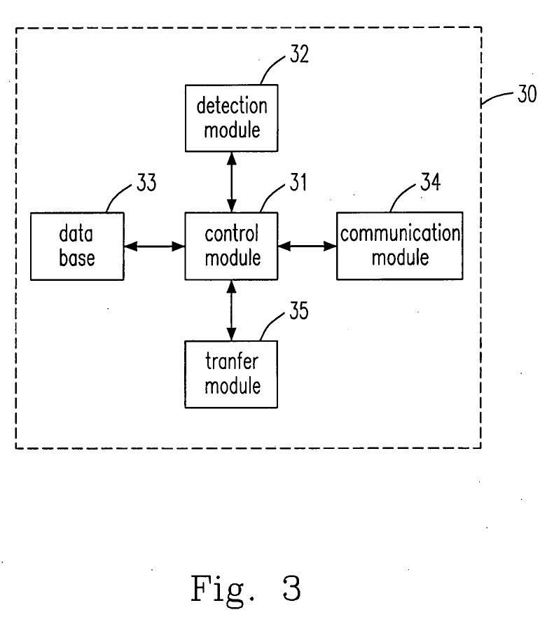

Please refer to FIG. 3, which is a schematic view showing the framework for the multi-mode transfer communication system according to the preferred embodiment of the present invention. The present system applies a medium device 30 as a main device for the present invention. The medium device 30 includes a control module 31, a detection module 32, a database 33, a communication module 34 and a transfer module 35. The control module 31 is connected to the detection module 32, the database 33, the communication module 34 and the transfer module 35. Further, the database 33 includes a contact list with a plurality of contact subject. While a connecting request from a user is detected by the detection module 32, the contact list from the database 33 would be retrieved by the control module 31 according to the connecting request. Moreover, the contact list is delivered by the communication module 34 to the user. Then, the user can select a specific contact subject from the contact subjects by using a voice input, an image input, a text input and a click to feed back the communication module 34. The specific contact subject could be identified by the control module 31 and determined by the user. The respective connection statuses of the respective contact subjects can be detected by the detection module 32 and the connection status of the specific contact subject would be delivered to the user by the communication module 34, thereby determining whether the user communicates with the specific contact subject in response to the connection status. While the user decides to communicate with the specific contact subject, the transfer module 35 can transfer the specific contact subject to communicate with the user.

In addition, while the detection module 32 detects that the specific contact subject fails to communicate with the user, i.e. including two possibilities of that the connection status for the specific contact subject cannot be communicated with the user or the user abandons to communicate with the specific contact subject. The detection module 32 generates a communication failure signal to the control module 31. The control module 31 sends a call to inform the specific contact subject according to the communication failure signal via the communication module 34 when the connect status of the specific contact subject is available. Then, the specific contact subject decides to communicate with the user in accordance with the call. The user can be communicated with the specific contact subject by the control module 31 based on the decision of the specific contact subject via the transfer module 35.

According to the mentioned description, the contact list is a hierarchical list and has a group list with a plurality of groups, and each group includes corresponding contact subjects. Such information is stored in the database 33. Thus, while the user is connected to the medium device 30, the communication module 34 delivers the group list to the user for selecting a specific group of the groups. Further, the communication module 34 delivers the corresponding contact subjects of the selected group to the user for selecting therefrom by retrieving from the database 33 via the control module 31 according to the selected group.

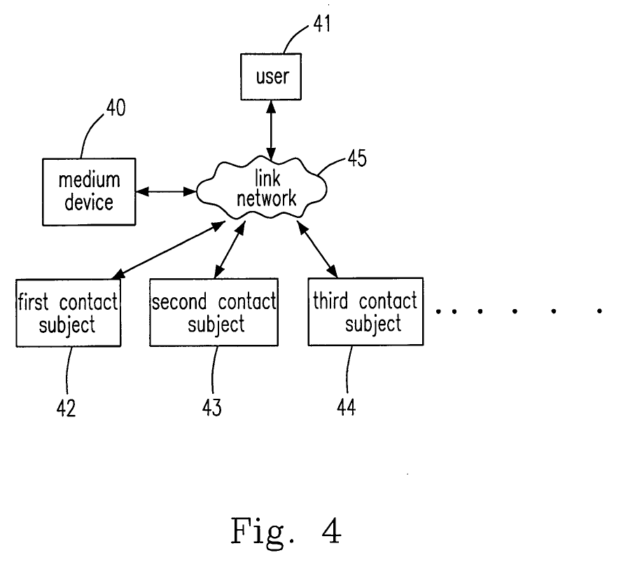

Furthermore, please refer to FIG. 4. The mentioned method and system can be configured to a link network 45, and the medium device 40, the user and a plurality of contact subjects 42, 43 and 44 includes a connection account, respectively. Accordingly, the user is connected to the medium device 40 via the respective connection accounts, and the medium device 40 is connected to the contact subjects 42, 43 and 44 via the respective connection accounts. Further, the link network 45 is one selected from a group consisting of Internet, Local Area Network (LAN), Wide Area Network (WAN) and Virtual Private Network (VPN).

According to the framework of FIG. 4, the user 41 can send a connecting request to connect with a medium device 40. After the user 41 is connected to the medium device 40 via the respective connection account, the medium device 40 can generate a greeting with a voice message or a text message to the user 41. Then, the medium device 40 can inform the user of all available contact subjects, i.e. the first, second and third contact subjects 42, 43 and 44, via the text message. Further, the user 41 selects a specific contact subject, such as the first contact subject 42, of the contact subjects 42, 43 and 44 for communicating therewith to the medium device 40 via a voice input, a text input and a click. The medium device 40 identifies the specific contact subject to be the first contact subject 42 and responds to the user 41. After determined by the user 41, the medium device 40 provides the connection status of the first contact subject 42 via an image. If the connection status of the first contact subject 42 is Offline, the user 41 can determine to select another contact subject, such as the second contact subject 43. If the connection status of the second contact subject 43 is Online, the user 41 can determine whether to communicate with the second contact subject 43 via the medium device 40. Then, the user 41 can be communicated with the second contact subject 43 via a transfer. Further, the communication between the user 41 and the second contact subject 43 would be a Peer-to-Peer Communication (P2P). Besides, the mentioned processes for selecting or determining by the user 41 could be performed by identifying the images about the user's motions. Furthermore, the present invention further provides a customized service. For example, the medium device 40 can identify the identity of the user 41 through the image identification, the voice identification or the password input to provide a customized transfer service therefor.

Therefore, the calling subscriber, i.e. the mentioned user, can use various interactive I/O interfaces, such as voice, image, text and click, of the present invention in the existing link network to obtain further complete information, such as the departments, a extension list, the connection statuses of the called subscriber and/or the message for whether the calling subscriber communicates with the called subscriber or send a call thereto.

Besides, the present invention is not only suitable for the automatic telephone switchboard system in a company to transfer the communication with the respective staffs in the company, but also suitable for the household to be regarded as an integrated window for the household members. Thus, the respective connection statuses of every household member could be detected by the present invention. Accordingly, if a calling subscriber fails to communicate with a specific member of the household members, the calling subscriber can determine whether to send a call with a message or requesting answer. Then, when the specific member is available, the specific member can obtain the information from the call to determine whether to communicate with the user. Therefore, the present invention provides a quite high decision-making power and flexibility for the calling subscriber and the called subscriber.

According to the above description, it is understood that the present multi-mode transfer communication system and the present method therefor effectively provide the interactive communication between the calling subscriber and the called subscriber for enhancing the convenience of the automatic telephone switchboard system. Further, the present multi-mode transfer communication system and the present method therefor can provide various interaction mechanisms to improve the defect with including only a voice interface in the conventional automatic telephone switchboard system. Furthermore, the present invention can be simply implemented by using the medium device to link the calling subscriber and the called subscriber so as to perform the present multi-mode transfer communication system and the present method therefor.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for performing a multi-mode transfer communication, comprising steps of:
(a) providing a medium device having a contact list with a plurality of contact subjects;
(b) detecting a connecting request from a user to provide the connection between the medium device and the user
(c) delivering the contact list to the user for selecting therefrom a specific contact subject;
(d) detecting a connection status of the specific contact subject for the user to decide to communicate with the specific contact subject or not; and
(e) transferring the specific contact subject to communicate with the user.

2. A method according to claim 1, further comprising steps of:
(f) generating a communication failure signal if a communication between the specific contact subject and the user fails; and
(g) sending a call to inform the specific contact subject when the connect status of the specific contact subject is available.

3. A method according to claim 2, wherein the step (f) further comprises a step of deciding whether the specific contact subject communicates with the user in response to the call.

4. A method according to claim 1, wherein the medium device, the user and the specific contact subject include a first connection account, a second connection account and a third connection account, respectively.

5. A method according to claim 4, wherein the user is connected to the medium device and the specific contact subject via the respective connection accounts.

6. A method according to claim 1, wherein the contact list has a group list with a plurality of groups, and each group includes corresponding contact subject.

7. A method according to claim 6, wherein the step (c) further comprises a step of delivering the group list to the user for selecting one of the groups to show corresponding contact subjects thereof.

8. A method according to claim 1, wherein the steps (c) and (e) are preformed by one selected from a group consisting a voice input, an image input, a text input and a click.

9. A method according to claim 1, wherein the connection status includes the status options including Online, Away, Do Not Disturb and Offline.

10. A multi-mode transfer communication system, comprising:
a detection module detecting whether a connecting request from a user exists;
a database including a contact list with a plurality of contact subject;
a control module retrieving the contact list from the database according to the connecting request;
a communication module delivering the contact list to the user for selecting a specific contact subject of the contact subjects and delivering a connection status of the specific contact subject, thereby determining whether the user communicates with the specific contact subject in response to the connection status.

11. A system according to claim 10, further comprising a transfer module transferring the specific contact subject to communicate with the user.

12. A system according to claim 11, wherein the detection module generates a communication failure signal to the control module while the specific contact subject fails to communicate with the user.

13. A system according to claim 12, wherein the control module sends a call to inform the specific contact subject according to the communication failure signal via the communication module when the connect status of the specific contact subject is available.

14. A system according to claim 13, wherein the specific contact subject decides to communicate with the user in accordance with the call.

15. A system according to claim 14, wherein the control module communicate with the user according to the decision of the specific contact subject via the transfer module.

16. A system according to claim 11, wherein the detection module, the database, the communication module and the transfer module are all connected to the control module.

17. A system according to claim 10, wherein the contact list is a hierarchical list having a group list with a plurality of groups, and each group includes corresponding contact subjects.

18. A system according to claim 17, wherein the communication module delivers the group list to the user for selecting one of the groups and show the corresponding contact subject thereof via the control module.

19. A system according to claim 17, wherein the detection module detects respective connection statuses of the contact subject.

20. A method for multi-mode transfer communication, comprising steps of:
(a) sending a connecting request by a user to connect with a medium device, wherein the medium device includes a hierarchical list having a group list with a plurality of groups;
(b) receiving the group list, wherein each group includes corresponding contact subject;
(c) selecting one of the groups from the group list to show the specific contact subjects corresponding to the selected group;
(d) selecting a specific contact subject from the contact subjects to show a connection status of the specific one; and
(e) determining whether to communicate with the specific contact subject via a transfer.
